(19) United States
(12) Patent Application Publication
(10) Pub. No.: US 2009/0296406 A1
(43) Pub. Date: Dec. 3, 2009

(54) Brightness enhancement film and backlight module

(76) Inventors: Yu-Sheng Teng, Tainan City (TW); Yi-Fan Chen, Tainan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/155,025

(22) Filed: May 29, 2008

(51) Int. Cl. F21V 5/02

(52) U.S. Cl. 362/309; 362/339

(57) ABSTRACT

This invention relates to a brightness enhancement film (BEF) and backlight module in which the brightness enhancement film comprises a plurality of continuous trapezoidal columnar units. The first surface and the second surface of each trapezoidal columnar unit are parallel to each other, and the first surface is provided with a plurality of micro-protrusions or micro-indentations in regular or irregular arrangement such that the brightness enhancement film has good beam-condensing performance by the provision of the trapezoidal columnar unit and the micro-protrusions or the micro-indentations on it, and brightness enhancement film is not damaged in the assembling process. Additionally, when brightness enhancement film is utilized in the backlight module, a backlight module with good light-output efficiency as well as low manufacturing cost can be obtained by only stacking in order of a brightness enhancement film, a planar light source and a reflector.

### BACKGROUND OF THE INVENTION

1. Field of the invention

The present invention relates to a brightness enhancement film (BEF) and a backlight module, particularly to a brightness enhancement film which has good beam-condensing performance and the surface of which is not easily damaged during assembling process; and to a backlight module which utilizes the brightness enhancement film of the present invention so as to obtain the manufacturing cost reduction effectiveness.

2. Brief Description of the Prior Art

The backlight module can be divided into edge lighting type and bottom lighting type according to the mounting of light source. The structure of edge lighting type backlight module includes, from up to down in order, a first diffuser, a brightness enhancement film, a second diffuser, a light guide, a reflector, and a light source provided at the side edge of the light guide. As to the structure of bottom lighting type backlight module, it comprises, from up to down in order, a first diffuser, a brightness enhancement film, a second diffuser, a light guide, a reflector and a light source both provided at the lower side of the second diffuser.

In the case of the edge lighting type backlight module, the light emitted from the light source is input from the side edge of the light guide and is output from the light-output face. Since the light generated from the light sources emitted on the light guide will dim gradually toward the side away from the incident light source together with the light emitted with respect to the incident light source becoming brighter, a phenomenon with alternating arrangement of brightness and darkness will be occurred. Moreover, moire is happened. Therefore, a second diffuser is provided on the light guide so that the light beam transmitted through the light guide conducts scattering. However, the light after scattering becomes too dark; there is a need to provide a brightness enhancement film on the second diffuser so as to enhance the light brightness. However, moiré will be happened again due to the provision of the brightness enhancement film. Thus, a first diffuser is again added on the brightness enhancement film so as to eliminate the moire produced by the mutual interference between the brightness enhancement film and the light guide. The other purpose of providing the first diffuser is to protect the surface of the brightness enhancement film from being scraped during assembling process so as not to deteriorate its luminance. However, not only the brightness (luminance) of the backlight module is influenced by the light attenuation effect resulted from the light transmission through the first diffuser but also the manufacturing cost of backlight module is raised due to the provision of the first diffuser.

### SUMMARY OF THE INVENTION

In view of the above defects existed in practical application of conventional brightness enhancement film and backlight module, the inventor provides a novel brightness enhancement film and a backlight module of the present invention after endless devotion to the research and improvement on the existing structure based on the abundant professional acknowledge in this art and practical experience in the relevant field.

The main object of the present invention is to provide a brightness enhancement film which has good beam-condensing performance and the surface of which is not easily damaged during assembling process, and to provide a backlight module which utilizes the brightness enhancement film of the present invention so as to obtain the manufacturing cost reduction effectiveness.

A brightness enhancement film of the present invention comprises a plurality of continuous trapezoidal columnar units, the first surface and the second surface of each trapezoidal columnar unit being parallel to each other, and the first surface being provided with a plurality of micro-protrusions or micro-indentations in regular or irregular arrangement.

Furthermore, the brightness enhancement film is made in such a manner that each of the plurality of continuous trapezoidal columnar units is formed as a S shape.

The brightness enhancement film is further made in such a manner that the adjacent trapezoidal columnar units have different heights, the high trapezoidal columnar unit and the low trapezoidal columnar unit being alternately arranged.

Furthermore, the brightness enhancement film is made in such a manner that each trapezoidal columnar unit has height variation, and each trapezoidal columnar unit presents undulate shape when observed from side view.

The brightness enhancement film is further made in such a way that the valley between two adjacent trapezoidal columnar units is provided with micro-protrusions or micro-indentations.

This invention further provides a backlight module using the abovementioned brightness enhancement film, in which a brightness enhancement film and a planar light source is provide in order from up to down, wherein said brightness enhancement film comprises a plurality of continuous trapezoidal columnar units, and the first surfaces of said trapezoidal columnar units being provided with a plurality of micro-protrusions or micro-indentations in regular or irregular arrangement.

### BRIEF DESCRIPTION OF THE DRAWINGS

The present invention will be better understood by the detailed description of the following preferred embodiments with reference to the accompanying drawings, in which:

FIG. 1 is a structural view showing the backlight module of the present invention.

FIG. 2 is a partial enlarged perspective view showing the first embodiment of the brightness enhancement film of the present invention.

FIG. 3 is a partial enlarged front view showing the first embodiment of the brightness enhancement film of the present invention.

FIG. 4 is a partial enlarged perspective view showing the second embodiment of the brightness enhancement film of the present invention.

FIG. 5 is a partial enlarged front view showing the second embodiment of the brightness enhancement film of the present invention.

FIG. 6 is a partial enlarged top view showing the third embodiment of the brightness enhancement film of the present invention.

FIG. 7 is a partial enlarged front view showing the fourth embodiment of the brightness enhancement film of the present invention.

FIG. 8 is a partial enlarged front view showing the fifth embodiment of the brightness enhancement film of the present invention.

FIG. 9 is a partial enlarged front view showing the sixth embodiment of the brightness enhancement film of the present invention.

FIG. 10 is a partial enlarged front view showing the seventh embodiment of the brightness enhancement film of the present invention.

FIG. 11 is a partial enlarged front view showing the eighth embodiment of the brightness enhancement film of the present invention.

FIG. 12 is a partial enlarged front view showing the ninth embodiment of the brightness enhancement film of the present invention.

### DETAILED DESCRIPTION OF THE PREFERRED EMBODIMENTS

The technical contents of the present invention will become more apparent from the detailed description of the preferred embodiments in conjunction with the accompanying drawings.

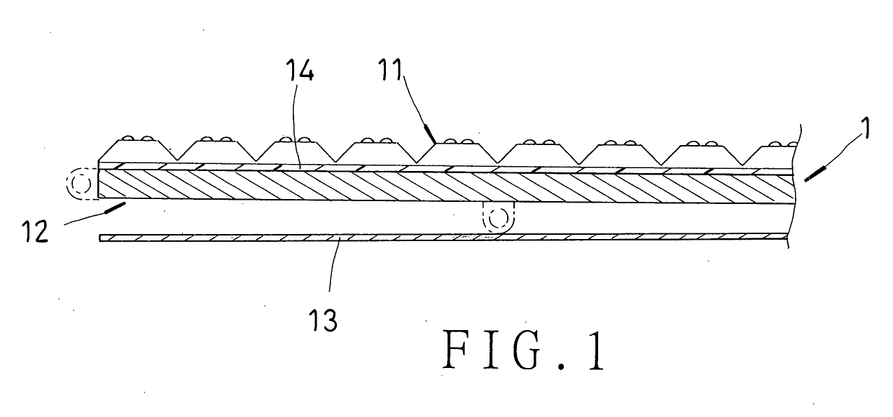

Firstly referring to FIG. 1 showing the structural view of the backlight module of the present invention, the backlight module (1) includes, from up to down in order, the stacking of a brightness enhancement film (11), a planar light source (12) and a reflector (13). Additionally, a diffuser (14) may be stacked between the brightness enhancement film (11) and the planar light source (12).

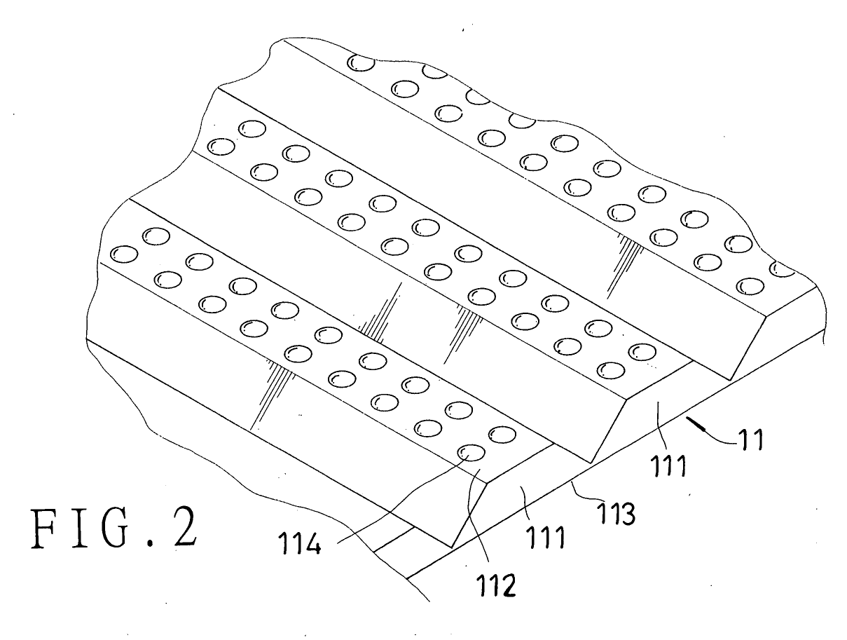

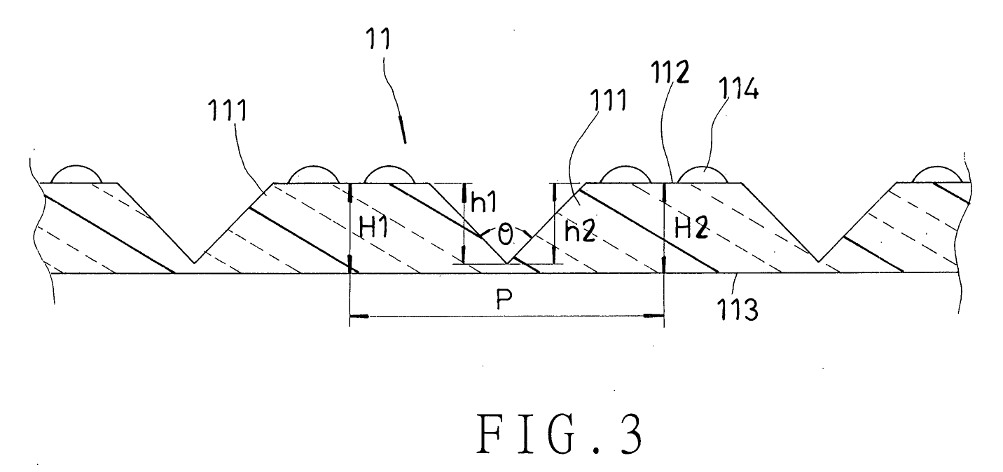

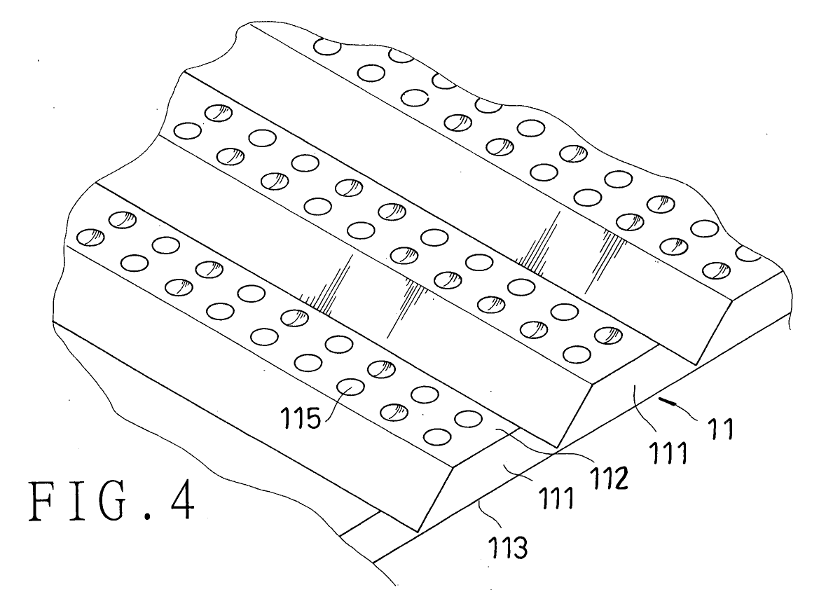

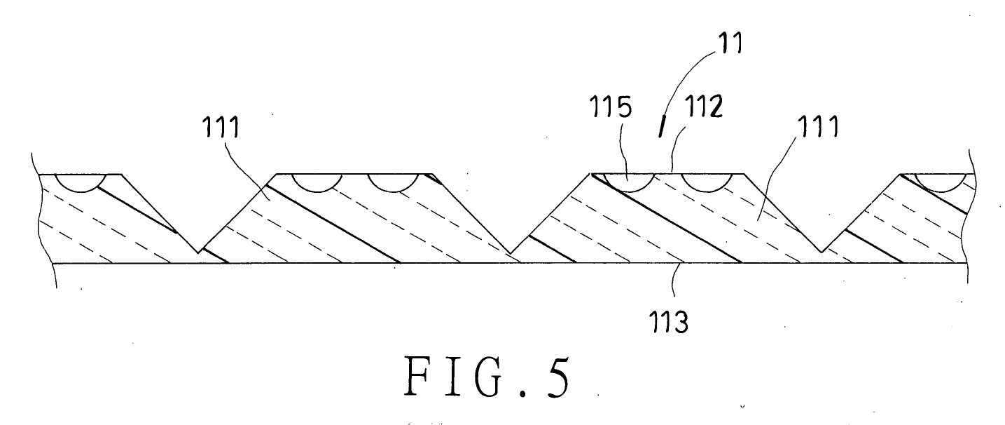

Referring to FIGS. 2 and 3 respectively showing the structural schematic view of the brightness enhancement film (11), the brightness enhancement film (11) is generally made of UV curing resin and comprises a plurality of continuous trapezoidal columnar units (111) which have a section of trapezoid shape. The first surface (112) and the second surface (113) of each trapezoidal columnar unit (111) are parallel to each other, and the first surface (112) is provided with a plurality of micro-protrusions (114) in regular or irregular arrangement, or micro-indentations (115) in regular or irregular arrangement as shown in FIGS. 4 and 5. Furthermore, if the horizontal distance from the center of one trapezoidal columnar unit (111) to the other one trapezoidal columnar unit (111) is defined as P, the angle of the valley included between two adjacent trapezoidal columnar units (111) is θ, then the following relations is established.

20 μm<P<150 μm

60°<θ<120°

Additionally, if the vertical distance from the first surface (112) to the second surface (113) of one trapezoidal columnar unit (111) is H1, the vertical distance from the first surface (112) to the second surface (113) of the other one trapezoidal columnar unit (111) adjacent to said trapezoidal columnar unit (111) is H2; the vertical distance from the first surface (112) of one trapezoidal columnar unit (111) to the tip point of the included angle θ of the valley is h1, and the vertical distance from the first surface (112) of the other one trapezoidal columnar unit (111) to the tip point of the included angle θ of the valley is h2, then the value of H1/H2 is in the range 0.5˜2, and the value of h1/h2 is also in the range 0.5˜2.

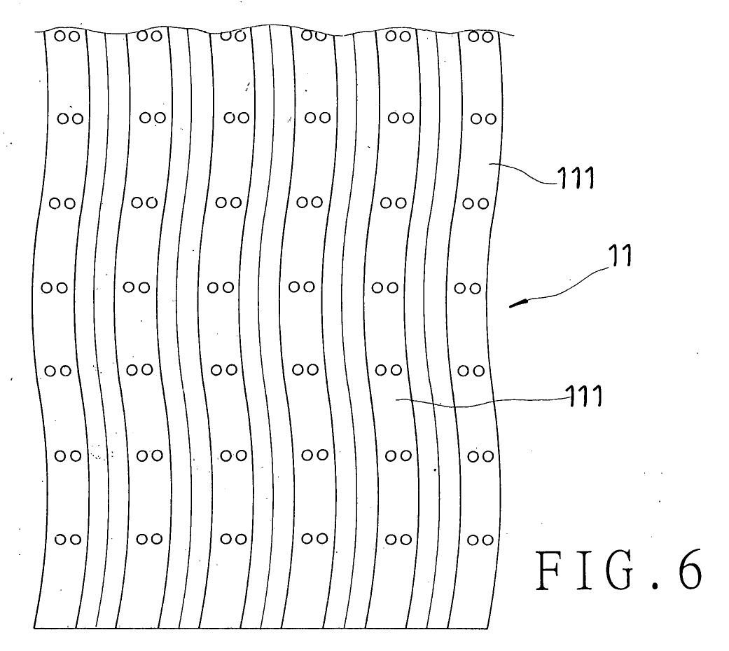

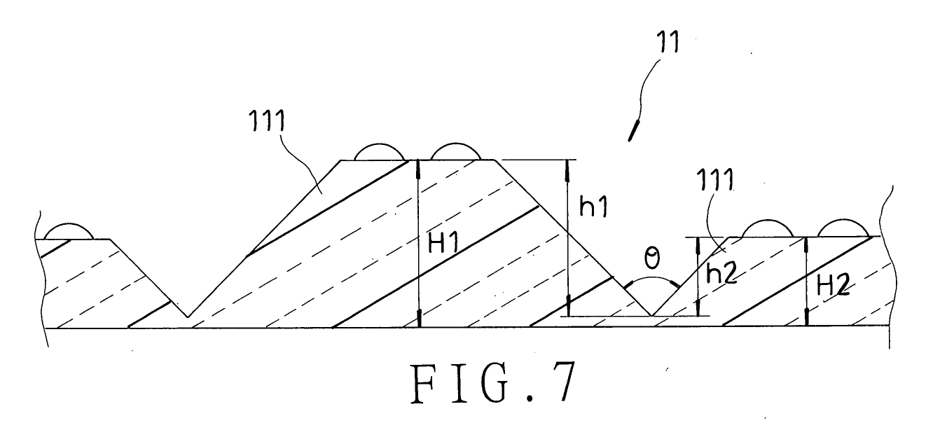

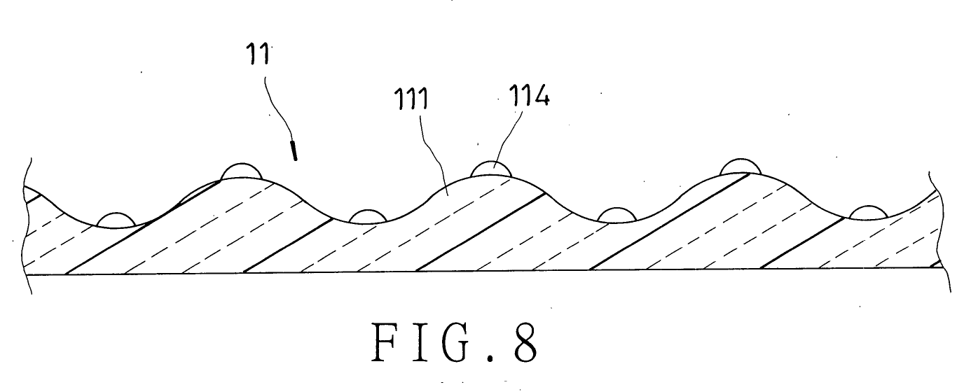

Further referring to FIG. 6, the brightness enhancement film (11) is further made in such a manner that the plurality of continuous trapezoidal columnar units (111) are formed as a S shape in parallel when viewed from top. In FIG. 7, the relationship H1≠H2 is set between two adjacent trapezoidal columnar units (111) such that height drop is present between one trapezoidal columnar units (111) and the other trapezoidal columnar units (111). The ratio H2/H1 is in the range 0.5˜2. In FIG. 8, each trapezoidal columnar unit (111) has height variation such that each trapezoidal columnar unit (111) presents undulate shape when observed from side view.

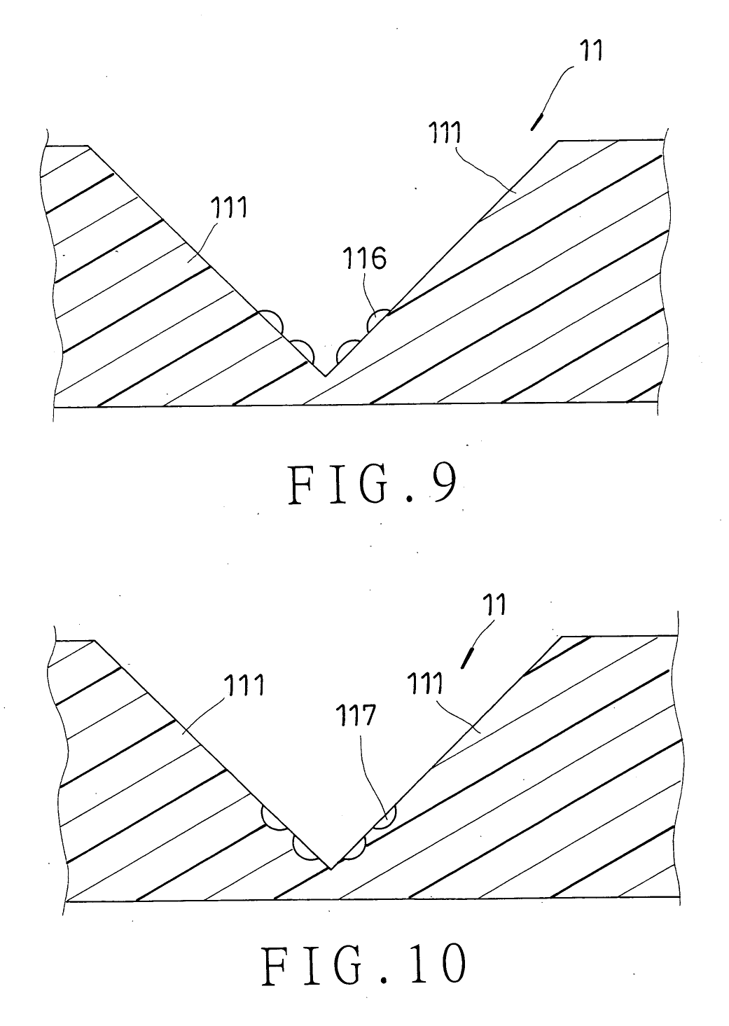

Referring to FIGS. 9 and 10, a plurality of micro-protrusions (116) or micro-indentations (117) are provided on the surface of the valley formed between two adjacent trapezoidal columnar units (111).

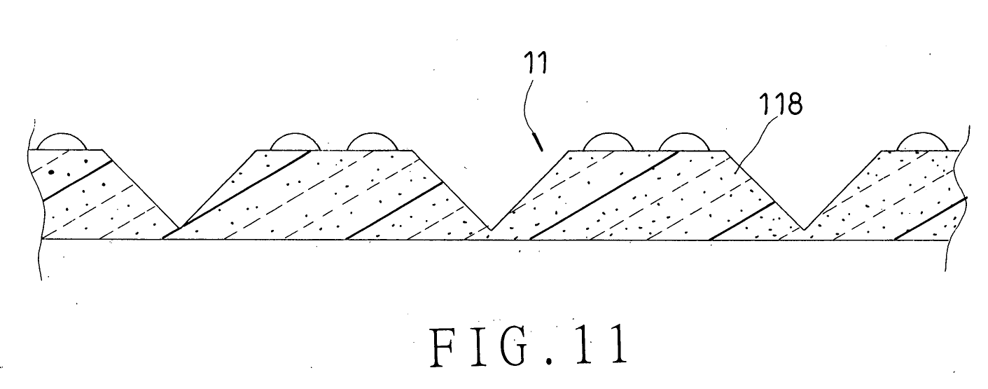

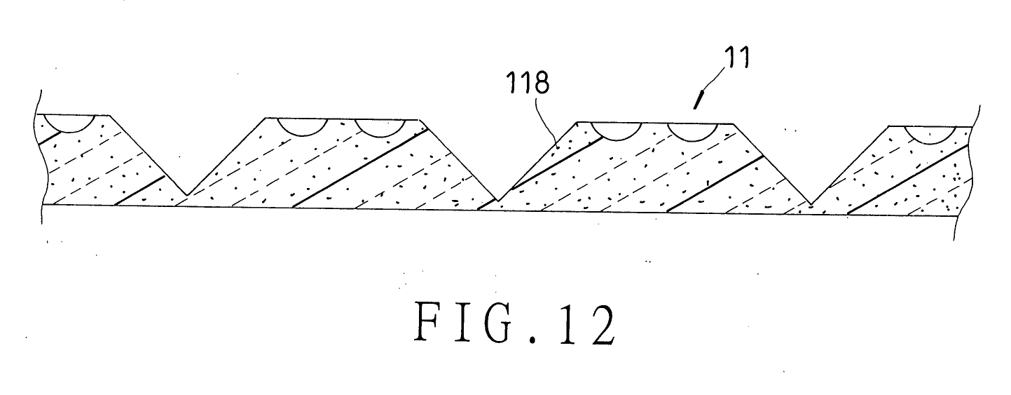

In FIGS. 11 and 12, the particles (118) with different refraction index and with particle size falling within the range 1˜10 μm is added to the brightness enhancement film (11).

Based on the foregoing, the brightness enhancement film and the backlight module of the present invention have at least the advantages set as follow.
1. Since the first surface of the brightness enhancement film of the present invention is a design of planar shape, it is not easy to be damaged during the assembling process.
2. The first surface of the brightness enhancement film of the present invention is provided with a microstructure enabling to raise beam-condensing effect of the brightness enhancement film so that the light emitted will not produce bright spot.
3. Since the backlight module of the present invention utilizes the brightness enhancement film of the present invention, the light emitted from the light-output face of the brightness enhancement film after stacking with the diffuser is very uniform without happening of bright spot and brightness is thus enhanced. Therefore, there is no need to provide another diffuser on the brightness enhancement film, the manufacturing cost is accordingly reduced.

Summing up above, the embodiment of this invention can reach expected effectiveness, and the specific configurations disclosed herein have yet not seen in the prior art of the same category of product, even has not been opened to the public before application.

While the present invention has been described with preferred embodiments in conjunction with the accompanying drawings, it is noted that the preferred embodiments and the drawings are purely for the convenience of description only, not intended to be restrictive on the scope of the present invention. Modifications and variations proposed by the person skilled in the art without departing from the spirit of the present invention are considered to be still within the scope of the present invention.

What is claimed is:

1. A brightness enhancement film, wherein said brightness enhancement film comprises a plurality of continuous trapezoidal columnar units the section of which are trapezoid, each said trapezoidal columnar unit having a first surface on which a plurality of microstructures are provided.

2. A brightness enhancement film as claimed in claim 1, wherein said microstructure is in a regular arrangement.

3. A brightness enhancement film as claimed in claim 1, wherein said microstructure is in an irregular arrangement.

4. A brightness enhancement film as claimed in claim 1, wherein said microstructure is a protrusion.

5. A brightness enhancement film as claimed in claim 1, wherein each of the plurality of continuous trapezoidal columnar units of said brightness enhancement film is formed as S shape when observed from top view.

6. A brightness enhancement film as claimed in claim 1, wherein said brightness enhancement film is made in such a manner that adjacent trapezoidal columnar units have different heights, the high trapezoidal columnar unit and the low trapezoidal columnar unit being alternately arranged.

7. A brightness enhancement film as claimed in claim 6, wherein the ratio between the heights of two adjacent high and low trapezoidal columnar units is in the range of 0.5˜2.

8. A brightness enhancement film as claimed in claim 1, wherein said brightness enhancement film is made in such a manner that each trapezoidal columnar unit has height variation, and each trapezoidal columnar unit presents undulate shape.

9. A brightness enhancement film as claimed in claim 1, wherein a valley is formed between two adjacent trapezoidal columnar units, and a plurality of fine structures are provided on the surface of said valley.

10. A brightness enhancement film as claimed in claim 9, wherein said microstructure is protrusions.

11. A backlight module, including a brightness enhancement film, a planar light source and a reflector provide in order from up to down, wherein said brightness enhancement film comprises a plurality of continuous trapezoidal columnar units the section of which are trapezoid, each said trapezoidal columnar unit having a first surface on which a plurality of microstructures are provided.

12. A backlight module as claimed in claim 11, wherein said microstructure is in regular arrangement.

13. A backlight module as claimed in claim 11, wherein said microstructure is in irregular arrangement.

14. A backlight module as claimed in claim 11, wherein said microstructure is protrusions.

15. A backlight module as claimed in claim 11, wherein each of the plurality of continuous trapezoidal columnar units of said brightness enhancement film is formed as S shape when observed from top view.

16. A backlight module as claimed in claim 11, wherein adjacent trapezoidal columnar units of said brightness enhancement film have different heights, the high trapezoidal columnar unit and the low trapezoidal columnar unit being alternately arranged.

17. A backlight module as claimed in claim 16, wherein the ratio between the heights of two adjacent high and low trapezoidal columnar units is in the range from 0.5 to 2.

18. A backlight module as claimed in claim 11, wherein said brightness enhancement film is made in such a manner that each trapezoidal columnar unit has height variation, and each trapezoidal columnar unit presents undulate shape.

19. A backlight module as claimed in claim 11, wherein a valley is formed between two adjacent trapezoidal columnar units, and a plurality of microstructures are provided on the surface of said valley.

20. A backlight module as claimed in claim 19, wherein said microstructure is a protrusion.
